(19) United States
(12) Patent Application Publication
(10) Pub. No.: US 2005/0281937 A1
(43) Pub. Date: Dec. 22, 2005

(54) Reduced-fat flavored edible oil spreads

(76) Inventors: Monoj K. Sarma, Bourbonnais, IL (US); Roger L. Daniels, Manhattan, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/873,702

(22) Filed: Jun. 22, 2004

(51) Int. Cl. A23D 7/00

(52) U.S. Cl. 426/601

(57) ABSTRACT

An oil-continuous edible spread has a reduced-fat characteristic, being composed of an oil phase and a flavored syrup phase, each making up a primary portion of the oil-continuous edible product. The oil-continuous edible product is a reduced-fat flavored spread. This spread finds application as an ambient-temperature eating spread for applying onto baked products. This spread also finds application as a roll-in or laminating fat for baking layered pastries. The spread can be used to make baked products which are reduced in fat by about 20 weight percent or more.

### BACKGROUND OF THE INVENTION

1. Field of the Invention

This invention generally relates to compositions which have a substantial edible oil content and which are significantly reduced in fat content. These compositions are especially suitable for use as substitutes for traditional fat, hydrogenated oil or spread products such as butter, margarine, cream cheese and the like. More particularly, the invention relates to reduced-fat flavored edible oil spread compositions which combine edible oil sources and a flavored syrup. In a preferred embodiment, an oligofructose also is included. The compositions also are excellent vehicles for delivery of valuable additives such as nutrients, phytosterol esters phytostanol esters, vitamins and so forth.

2. Description of Related Art

Spreads have long been used in baking and as fillings and toppings. Examples include roll-in or laminating margarine-type compositions for making pastry and bread products such as those which are baked to exhibit a flaky consistency. Edible oil based products and compositions are well-known to provide consistency, flavor, texture and functional attributes that are very suitable for these types of applications. Examples are margarines, whether solid or spreadable, which are primarily composed of hydrogenated edible oils. A typical edible oil product suitable for these types of uses, including roll-in or laminating spreads, have a fat content of at least 80 weight percent, based on the total weight of this type of spread.

Products which are suitable for use as roll-in spreads often also have another application which typically is associated with baked goods, but not with the baking procedure itself. These products also often are characterized as spreads. Usually, they are formulated to have a spreadable consistency when used at room temperature and even when used at refrigerated temperatures. Examples of traditional spreads in this regard include cream cheese, spreadable margarine, whipped butter, and the like. Such traditional spreads also have a high fat content, typically on the order of 80 weight percent or more of fat, based on the total weight of this type of spread.

While fat sources can be important for a fully balanced diet, certain dietary regimens strongly encourage reduction in fat intake. Individuals on restricted diets of this type, or individuals simply wishing to reduce fat intake, are likely to scrutinize the amount of spreads of these two basic types and other similar products which they ingest. Many individuals who would prefer to avoid a great reduction in the intake of such spreads would welcome an alternative solution.

Heretofore, cutting back on the levels at which spreads of this type are consumed has been the best alternative available to individuals wishing to reduce fat in their diets originating from spreads. Alternatives to reducing intake levels can include spread substitutes which often do not have satisfactory sensory, function and texture characteristics which approximate those of traditional spreads used as baking ingredients and/or which are fat based and suitable for applying onto other food products.

### SUMMARY OF THE INVENTION

In accordance with the present invention, edible oil spreads are provided which are compositions that are substantially lower in fat content than edible oil originating traditional spreads. These compositions have a maximum fat content of about 60 to 65 weight percent. These spread compositions further include a substantial quantity of a flavored syrup composition. These two primary components of the spread compositions are combined to provide oil-continuous edible products. In a preferred composition, a water-binding agent also is included which performs emulsifying and/or texturizing functions. When desired, these compositions can be formulated with components which perform important nutrition or health functions. These include phytosterol ester components and nutrient components, for example.

The reduced-fat flavored spread compositions according to the invention have the ability to function well in food systems, especially roll-in spreads for baking multi-layered pastries and breads. Other suitable applications include spreads to be applied to ready-to-eat food products without having to heat and/or melt the spreads before consuming the products.

It is accordingly a general aspect or object of the present invention that it provides edible oil spreads having a substantially reduced-fat content when compared to edible oil spreads of traditional formulations.

Another aspect or object of this invention is that it provides a reduced-fat flavored spread having properties similar to those of full-fat spreads for which they provide viable substitutes, including spreadability and plastic characteristics.

Another aspect or object of this invention is that it provides a reduced-fat spread which can replace on the order of 80 to 100 weight percent of the traditional fat ingredients of a food product.

Another aspect or object of the present invention is that it provides edible oil spreads suitable for use as baking ingredients and that are reduced in fat content by at least about 20 weight percent, preferably at least about 22 weight percent when compared with spreads typically used for such applications.

Another aspect or object of this invention is that it provides an oil-continuous edible product which includes considerable quantities of non-oil components.

Another aspect or object of the present invention is that it provides an excellent vehicle for delivering valuable components into the body of an individual, including those having cholesterol adjusting properties and those having important nutritive qualities.

Other aspects, objects and advantages of the present invention will be understood from the following description according to the preferred embodiments of the present invention, specifically including stated and unstated combinations of the various features which are described herein.

### DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

The present invention is directed toward edible oil based compositions which are considerably reduced in fat content when compared to edible oil spreads such as margarines or whipped margarines. These are referred to herein as spreads, which is intended to encompass edible oil based products that are generally along the lines of margarine types of products which are suitable for use either during baking or as a stand-alone composition that is pleasingly edible as a topping or filler that is not necessarily intended to be baked into a food product but to be a component of a ready-to-eat food.

The reduced-fat flavored spreads are extrudable, and they have a smooth texture and fruity flavors and/or savory flavors. When fruity flavors are selected, examples include various berry flavors, apple cinnamon flavors and so forth. At times it may be useful to combine synthetic flavors and natural flavors as desired. Savory flavors include butter, garlic, garlic butter, lemon butter, pesto, basil, parsley and oregano. Particularly when used as a roll-in or laminating fat or margarine, the reduced-fat flavored spreads have excellent extensibility and viscoelasticity. They are especially suitable for rolling and folding by rolling pins and reverse sheeter equipment.

The oil phase component of the spread composition can include shortenings of the type currently used in full-fat spreads. Such shortenings are at times referred to as base oils generally known for use in margarines and shortenings. Typically these originate as so-called domestic oils, and at times also incorporate palm and tropical oil sources. Domestic oils for use in the oil phase according to this invention include soybean oil, corn oil, cottonseed oil, canola oil, safflower oil, sunflower oil, peanut oil, olive oil, oil from grain plants and identity preserved oils such as identity preserved canola oil and the like. Examples of tropical oil sources include palm oil, palm kernel oil and coconut oil.

The oil sources are the primary constituent of the oil phase. Usually the oil sources are hydrogenated. Preferably, the fat component of the oil phase is a hydrogenated domestic and/or tropical oil. Examples include a hydrogenated blend of soy and cottonseed oils. The hydrogenated oils provide the source of the solids profile which is exhibited by the flavored spread according to the invention. These oil sources typically comprise at least approximately 80 weight percent, based on the weight of the oil phase component. Often this amount approximates virtually the entirety of the oil phase component. A typical range for an hydrogenated edible oil source is between about 85 and about 99 weight percent, based on the weight of the oil phase component.

Emulsifiers preferably are included in the spreads. It is often advantageous to incorporate them into the oil phase component. Examples include glycerides, lecithin and specially formulated linear emulsifiers. Typically such components will be present in the oil phase at a total level of not greater than about 15 weight percent, often not greater than about 10 weight percent, based on the total weight of the oil phase component. When desired, flavoring components can be included, such as butter flavor components. Often these are incorporated into the oil phase component.

The other principal component of the reduced-fat spreads is the aqueous phase component. This is included at a level of at least about 30 weight percent, based upon the total weight of the reduced-fat spread. A typical range is between about 30 and about 70 weight percent of the reduced-fat spread. Usually, an acceptable level is between about 32 and about 60 weight percent of the flavored reduced-fat spread. A preferred range is between about 33 and about 65 weight percent, with an especially preferred range being about 34 and about 58 weight percent, all based upon the total weight of the flavored reduced-fat spread.

The aqueous phase composition includes a flavored syrup. The flavored syrup makes up much of the aqueous phase, and at least about 80 weight percent of it. A typical range for the flavored syrup is between about 85 and about 99 weight percent. Based upon the total weight of the reduced-fat spread, this flavored syrup is present at between about 35 weight percent and about 65 weight percent, more preferably between about 40 weight percent and about 60 weight percent, based upon the total weight of the flavored reduced-fat spread.

The flavored syrup composition includes a flavoring agent. Preferably, the flavoring agent is a fruit or vegetable source, including juices, purees and the like. Flavorants also can be present. Syrups of this type are water-based. Often the flavoring agent and water will be provided as an existing syrup. The flavoring agent syrups typically include from about 50 to about 55 weight percent water.

The aqueous syrup composition has the ability to incorporate components such as real juice, so-called salted wine (which is a source for flavonoid compounds), as well as savory flavors and the like. No gelling agents are required in formulations according to the invention in order to achieve the good spreadable attributes which are needed for a margarine spread or laminating fat. Thus, no gelling agents are required in either the aqueous syrup phase or the hydrogenated fat phase.

The flavored aqueous phase also often will include a sweetener. Natural and artificial sweeteners are possible. Examples of natural sweeteners are sucrose, glucose, fructose and high fructose corn syrup. Inclusion of a natural sugar will be at a level of between 0 and up to about 4 weight percent, based upon the total weight of the reduced-fat flavored spread, typically between about 1 and about 3 weight percent. Most artificial sweeteners will be at a lower level, as a generally appreciated in the art. A salt, such as sodium chloride, also can be added into the aqueous phase, such being at a level of between 0 and about 1 weight percent, based upon the total weight of the flavored spread.

For many aqueous syrup phase formulations, a pH-adjusting agent can be included. Same also can be included for the purpose of flavor modification, such as by adding a food-grade acid in order to enhance tartness. A preferred agent in this regard is citric acid. Usually such a pH adjusting agent will be present at a level of from 0 to about 0.5 weight percent based on the total weight of the reduced-fat flavored spread. Adjusting the pH also can be of value in aiding formation and maintenance of the oil-continuous edible product, typically by enhancing water binding.

The aqueous syrup phase further can include ingredients often present in fruit syrups and the like. These include starches such as modified food starch, flavors, colors, and preservatives. When included, each is added at a level generally known in the art.

The reduced-fat flavored spread according to the invention has a solid fat content (SFC) at 10° C. of at least 30 units. The SFC at 10° C. of the flavored blend can be as high as 55 units. These SFC values can be varied somewhat, depending upon the plasticity desired for the flavored spread. An example of a suitable plasticity level would be for the flavored spread to have a consistency approximating that of cream cheese or a whipped butter or margarine at about 10° C.

A component which is important to maintaining the oil-continuous consistency of the flavored spread according to the invention is the inclusion of the emulsifier. As noted previously, in a typical approach, the emulsifier is incorporated into the oil phase. Often the emulsifier can be provided as a system containing multiple emulsifiers.

It is particularly important that the emulsifier be included in such a way as to interface with the water of the flavored syrup phase. A primary function of the emulsifier is to prevent water separation from the finished flavored spread. In a preferred arrangement, the emulsifier is provided as an emulsion system comprising a plurality of components having emulsifying properties. Such components can fall into three general categories. One category encompasses glycerides and incorporates monoglyceride sources as a primary emulsifier. Another incorporates lecithin sources. Another incorporates polyglycerol ester (PGE) sources.

When the emulsifiers are included within an emulsifier system, which is the preferred approach according to the invention, the system includes at least two such emulsifiers. The glyceride component comprises from 0 up to about 80 weight percent of the emulsifier system. Preferably, the glyceride component is present at between about 10 and about 75 weight percent, based upon the total weight of the emulsifier system. Usually, the greater the monoglyceride content, the lower the levels of glycerides which are needed for emulsification. The lecithin component can be present at a level of between 0 and about 50 percent, based upon the total weight of the emulsifier system. When the lecithin is present, it preferred range is between about 10 weight percent and about 45 weight percent, based upon the total weight of the emulsifier system. The polyglycerol ester level is between 0 and about 90 weight percent, preferably between about 50 and about 85 weight percent, based upon the total weight of the emulsifier system.

Considering the content of the emulsifiers within the reduced-fat flavored spread, typically the glyceride component is at a content of not greater than about 2 weight percent of the total flavored spread, typically between about 0.5 and about 1.5 weight percent of the flavored reduced-fat spread. When present, lecithin will be at a level of not greater than about 2 weight percent, typically not greater than about 1 weight percent, based upon the total weight of the spread. The polyglycerol ester, when in the emulsifier system, will be at a level of not greater than about 5 weight percent, based on the total weight of the flavored spread, typically between about 1 and about 4 weight percent of the spread.

Concerning the monoglycerides, they can be sourced from domestic oils or from oils such as palm oil. Included are DIMODAN® of Danisco Ingredients. A typical such emulsifier is DIMODAN®O, which contains at least 90 weight percent monoglyceride sourced from soybean oil which is hydrogenated. Such has a dropping point of 57° F. (14° C.) and an iodine value of 60 IV units. A typical range for monoglycerides in the glyceride component is an iodine value of from 55 to 65 IV units.

Polyglycerol fatty acid ester emulsifiers of the especially preferred type for inclusion in the emulsifier system are made from glycerol that was polymerized to an average of from 3 to 4 units long. The fatty acids of the PGE emulsifier can be from either a shortening or from a palm fraction. Other sources of fatty acids can be substituted as generally known in the art.

For preferred PGE emulsifiers, the average degree of esterification ranges from 1 to 2 fatty acids per polyglycerol molecule. The polyglycerol units formed by a conventional process allows the production of considerable amounts of cyclic compounds. Preferably, the polyglycerol units of the PGE materials are formed by a process that produces substantially all non-cyclic forms of such compounds. Emulsifiers of this latter type are available from Lonza as linear PGE compounds.

Another component which preferably is included within the flavored spread is an oligofructose or fructo-oligo-saccaride, also known as inulin. This is a texturizing agent from natural sources, derived from vegetable sources such as asparagus, Jerusalem artichoke, chicory, or the like. Preferably, this inulin compound is included within the flavored syrup phase. It has been found to be useful in binding water in the flavored spread. The water binding provided by inulin cooperates with the water binding provided by the emulsifier or the emulsifier system in order to better provide an acceptable consistency for a product to be used as a spread on bread, bagels, other ready-to-eat bakery products, and similar products. While inulin is known for its health benefits, when inulin is included in the present formulations, it provides the benefit of managing the total amount of water in the formulation so that it remains within the formulation during handling and use.

Furthermore, the reduced-fat flavored spread formulations are suitable for accepting, and being carriers for, components that are understood to have value for use in food products. These generally include cholesterol affecting components, nutrients, minerals, vitamins and other health-enhancement components.

For example, sterol ester type products are understood to be useful in lowering serum LDL cholesterol in humans. When included, such a phytosterol component will be included at levels between about 1 and about 10 weight percent, based on the total weight of the reduced-fat flavored spread. Typically, a phytosterol will be present at between about 1 and about 7 weight percent, when included.

With further reference to the phytosterols that serve as the basis for the phytosterol ester components that are combined with the oil phase and/or flavored syrup phase according to the invention, specific details concerning phytosterols can be found in U.S. Pat. No. 6,117,475, No. 6,139,897, No. 6,277,431, U.S. patent application Publications No. 2002/0031595 and No. 2002/0045000, and International Publications No. WO 01/13733, No. WO 01/32029 and No. WO 01/91587. Specific details concerning phytosterol esters and microparticles of phytosterol esters are found in U.S. Pat. No. 6,087,353 and U.S. patent application Publication No. 2002/0048606. Each of these patents and patent publications is incorporated by reference hereinto.

The term “phytosterols” when referring to the components used in the compositions according to the present invention encompass phytosterols and/or phytostanols or derivatives of these types of compounds. It is recognized that the presence of the sterol component is useful in lowering serum cholesterol and serum triglyceride levels, as well as enhancing overall dietary efficacy. It is generally accepted, but not with certainty, that this can be explained by similarities between their respective chemical structures. By this explanation, the phytosterol displaces cholesterol from the micellar phase, thereby reducing cholesterol absorption and/or competing with receptor and/or carrier sites in the cholesterol absorption process.

Examples of compounds which fall within a meaning of “phytosterol” include sitosterol, campesterol, stigmasterol, brassicasterol, demosterol, chalinosterol, poriferasterol, coioanasterol, and natural or synthesized forms or derivatives, including isomers. Also included are compounds identified by the term phytostanol, including saturated or hydrogenated phytosterols and all natural or synthesized forms and derivatives, including the isomers. It will be appreciated that these components can be modified, such as adding side chains and also fall within the preview of the term phytosterol.

Phytosterols are typically attained from natural sources, most typically from the processing of plant oils or marine oils. Sources include vegetable oils and fish oils, vegetable oils include corn oil, wheat germ oil, soy extract, rice extract, rice bran, canola oil and sesame oil. Other sources can include tall oil pitch or soap such as those which are byproducts of the forestry industry.

Phytosterol esters are available from public sources, including from Forbes Medi-Tech, Inc. An example is PHYTROL®, a registered trademark of Forbes Medi-Tech, Inc. Compositions are sold under this brand name as cholesterol lowering agents. A typical such composition is composed of plant sterols and stanols having 14.5% campesterol, 2.4% campostanol, 50.9% beta-sitosterol, and 18.9% sitostanol. The PHYTROL® product is a fine crystalline waxy powder. Its particle size characteristic is such that greater than 80% of the particles pass through a 0.8 mm sive and greater than 98% of the particles pass through a 2.0 mm sive. PHYTROL® phytosterol compositions comprise from 38 to 79 weight percent sitosterol, based on the total weight of the anhydrous composition, 4 to 25 weight percent of campesterol, 6 to 18 weight percent sitostanol, and 0 to 14 weight percent campostanol. At least 97 weight percent of the components are in the form of a sterolester, and no more than 3 weight percent are free sterols. An exemplary sterolester in this regard is a phyto-S-sterol-10 ester. Such has a softening point of between 15° C. and 30° C. and is substantially insoluble in water at 25° C. Such a sterolester is liquid above 40° C.

With more particular reference to the phytosterol ester component, it is preferred that the quantity of stanol structures included in this component be minimized. The stanol structure is associated with hydrogenization is associated with trans-isomer structures, which have been the subject of negative health concerns. In addition, excessive hydrogenization detrimentally affects clarity of the compositions. Typically, the stanol or phytostanol content in the phytosterol ester components according to the invention will be no greater than about 20 weight percent, based upon the total weight of the phytosterol ester component. Preferably, the amount of stanol or phytostanol compounds within the phytosterol ester component is not greater than about 15 weight percent.

In the general category of nutrients are whey-originating materials. These can be added to the flavored spread, for example within the aqueous syrup phase. An example is whey protein concentrate, typically having a whey concentration on the order of 80 weight percent. Between 0 and about 5 weight percent whey protein concentrate can be included, based upon the total weight of the reduced-fat flavored spread. When present, this level preferably is between about 0.5 and about 3 weight percent, based upon the total weight of the flavored spread. The presence of such whey components assists in imparting a cream cheese type of texture to the flavored spread. The acidity of the aqueous syrup component causes protein curdling which helps to create a creamy cheese texture.

Another component which may be added in order to enhance nutritive properties includes natural sources of vitamins and the like. One such component is folic acid, which belongs to the B-vitamins group. When present, same will be at levels of between about 50 micrograms/gram and about 100 micrograms/gram, based upon the total weight of the flavored spread, without detrimentally affecting the functional properties of the reduced-fat spread. A level of about 400 micrograms equates to 100 percent Daily Value (DV) for folic acid per 14 gram serving size. Other nutrients and vitamins can be added in similar fashion and at selected DV levels.

Examples now are provided in order to illustrate the concepts of the invention with a certain degree with specificity.

### EXAMPLE 1

A flavored margarine spread was prepared as a nominal 40 percent fat spread. This represents approximately half of the fat of a typical margarine spread, which usually comprise about 80 weight percent fat. The formulation combined hydrogenated vegetable oil with a flavored spread.

This product analyzed as having 40.9 weight percent fat, 28.97 weight percent moisture, 29.55 weight percent carbohydrate materials including starch, sugar and inulin. The percent salt was 0.58 weight percent. The Mettler dropping point, or melt point was 46.6° C. The SFC at 10° C. was 47.36 units. At 21.1° C., the SFC was 32.02 units. At 26.7° C., the SFC was 24.18 units. At 33.3° C., the SFC was 14.93 units, and at 40° C., the SFC was 7.10 units.

### EXAMPLE 2

Example 1 was generally repeated, except the target was a reduced-fat flavored spread having a nominal 60 percent fat content. This particular product analyzed as having 60 weight percent fat, 17 weight percent moisture, 19.49 weight percent of the carbohydrate materials, and 0.47 weight percent salt. The MDP melting point was 41.0° C. The SFC at 10° C. was 38 units. At 21.1° C., the SFC was 23.92 units. At 26.7° C., the SFC was 16.7 units. At 33.3° C., the SFC was 8.90 units, and at 40° C., the SFC was 2.66 units.

### EXAMPLE 3

An oil phase composition was prepared from 72.7 pounds of hydrogenated soybean oil, which was formulated into a flavored spread having 58.16 weight percent hydrogenated shortening, based upon the total weight of the flavored spread. Also included within the oil phase composition were 1.25 pounds (1 weight percent) of DIMODAN®, one pound (0.8 weight percent) lecithin, and butter flavor.

The aqueous phase composition was prepared by combining 43.52 pounds of flavored syrup containing 3 berry sources, which has real berry components and juice and natural flavorings (hereinafter “mixed berry syrup”), which represented 34.82 weight percent of mixed berry syrup within the finished flavored spread. Also included in the aqueous phase was granulated sugar (3.13 pounds, or 2.5 weight percent), inulin (2.5 pounds or 2 weight percent), salts (0.63 pounds or 0.5 weight percent), and anhydrous citric acid (0.23 pound or 0.18 weight percent).

The oil phase composition and the aqueous composition were combined in a churn tank in order to provide a reduced-fat flavored margarine spread. The spread has a fat content on the order of 58 weight percent.

### EXAMPLE 4

A formulation was prepared in accordance with Example 3, except the oil phase composition and the aqueous phase composition were formulated as follows to provide a reduced-fat flavored spread having a fat content of about 39 weight percent.

The oil phase composition had 49.2 pounds of anhydrous soybean and cottonseed oil, representing a 39.35 weight percent fat content for the flavored margarine spread. Also included were 0.56 pounds (0.45 weight percent) of DIMODAN®, 3.13 pounds of linear polyglycerol ester of a linear variety, available as 3-1 SH from Lonza (2.5 weight percent of the flavored margarine spread) and butter flavor. The aqueous phase composition had 68.7 pounds of mixed berry syrup (54.96 weight percent of the flavored margarine spread). Also added were 2.5 pounds (2 weight percent) of granulated sugar, 0.63 pounds (0.5 weight percent) of salt, and 0.26 pounds (0.2 weight percent) of anhydrous citric acid.

### EXAMPLE 5

An oil phase composition was prepared from 39.35 weight percent of hydrogenated soy and cottonseed oil blend. This was combined with an emulsion system composed of 0.45 DIMODAN®, 0.5 weight percent lecithin, and 2.5 weight percent linear polyglycerol ester (3-1-SH), each percentage being based upon the total weight of the subsequently prepared flavored margarine spread.

To this oil phase were added four different formulations of mixed berry syrup phase compositions to prepare four reduced-fat flavored spreads. Each included 0.5 weight percent of salt and 2 weight percent of inulin. One of these syrup phases had 55.2 weight percent mixed berry syrup, and no whey protein. Another formulation had 1 weight percent whey protein concentrate (80 percent whey) and 54.2 weight percent mixed berry syrup. A third syrup phase contained 1.5 weight percent of the same whey protein concentrate and 53.7 weight percent mixed berry syrup. The fourth syrup phase contained 2 weight percent of the whey protein concentrate and 53.2 weight percent of the mixed berry syrup.

Each syrup phase was combined with the oil phase of this Example and evaluated for cream cheese type of texture for the finished spread. At the whey protein levels of 1.5 weight percent and 2 weight percent, a cream cheese type of texture resulted. The 1 percent protein level formulation resulted in a texture effect which was not as pronounced. It was noted that the high acid content of the mixed berry syrup helped the protein to curdle and create the desired cream cheese texture.

### EXAMPLE 6

An oil base and a syrup base were prepared and were then blended together to provide a nominal 40 percent flavored spread. Different mixed berry syrups were used in order to vary coloration and taste. Each had the same formulation. The oil base composition was 39.35 weight percent hydrogenated soy and cottonseed blend, 0.45 DIMODAN® monoglyceride composition, 2.5 weight percent linear polyglycerol ester, 0.4 weight percent butter flavor, along with 55.15 weight percent of one of the mixed berry syrups, 2 weight percent inulin, and 0.5 weight percent sodium chloride.

### EXAMPLE 7

A functional reduced-fat flavored margarine spread having a sterol component and vitamin fortification was prepared as a nominal 60% fat roll-in spread suitable for use in bakery applications.

The following oil phase ingredients were combined and heated up to 135 to 140° F. for suitable mixing:

hydrogenated soy oil with low levels of hydrogenated cottonseed oil (53.28 weight percent), 5 weight percent phyto-S-sterol, one weight percent DIMODAN® monoglyceride material, 0.4 weight percent lecithin, together with butter flavor, D-alpha tocopherol as a vitamin E source, vitamin A in cottonseed oil, and a vitamin D source.

The syrup phase was prepared by adding to a mixing kettle with a mixing rod attached 34.82 weight percent mixed berry syrup, 2.5 weight percent granulated sugar, 2 weight percent inulin, 0.5 weight percent salt, and 0.18 weight percent anhydrous citric acid. This was done by heating the mixed berry syrup and adding a dry mixture of the other components.

Then the aqueous syrup phase was added to the oil phase and allowed to mix through a gear pump for 15 minutes. Blending continued in a churn tank and votator. This proceeded to cooling and crystallization to the desired consistency. The resulting product was a functional margarine product useful as a lamination spread for baked goods and which includes sterol ester and added vitamins.

### EXAMPLE 8

A reduced-fat flavored margarine spread was prepared in accordance with the invention to have a nominal 60 percent fat content. Comparison testing was conducted using a conventional 80 percent roll fat roll-in spread, namely MONARCH® no-Palm roll-in margarine. Croissants were baked in a typical formulation of 25 percent of either of the roll-in components and 75 weight percent of the dough.

The reduced-fat flavored margarine spread was easy to deposit into the dough, being smooth and paste-like. It was noted that the croissants made with the flavored margarine spread did not rise as much as the control croissants, the test croissants being more bread-like than flaky when compared with the control croissants. The test croissants had a pleasant natural fruit flavor of mixed berry. The flavored margarine spread seemed to be somewhat softer in solids than the control, and the test spread worked into the dough slightly more during sheeting than the control. All in all, the test product was judged as producing quite an appealing croissant. Danish and other puff pastry were successfully prepared using a 60 percent fat flavored spread.

It will be understood that the embodiments of the present invention which have been described are illustrative of some of the applications of the principles of the present invention. Numerous modifications may be made by those skilled in the art without departing from the true spirit and scope of the invention, including those combinations of features that are individually disclosed or claimed herein.

1. A reduced-fat flavored spread, which is prepared from a combination of phases, comprising:
up to about 65 weight percent of an oil phase component, based upon the total weight of the reduced-fat flavored spread;
said oil phase component including at least about 80 weight percent of an hydrogenated vegetable oil component, based on the weight of the oil phase component;
a least about 35 weight percent of an aqueous flavored syrup phase component, based upon the total weight of the reduced-fat flavored spread, said aqueous flavored syrup phase component including at least about 30 weight percent of a flavor component, based upon the total weight of the reduced-fat flavored spread;
up to about 8 weight percent of an emulsifier component, based upon the total weight of the reduced-fat flavored spread; and
said reduced-fat flavored spread is an oil-continuous edible product combining said oil phase component and said aqueous flavored syrup phase component.

2. The composition in accordance with claim 1, further including up to about 8 weight percent, based on the total weight of the reduced-fat flavored spread, of a natural source water binding agent.

3. The composition in accordance with claim 2, wherein said natural source water binding agent is an oligofructose and is present at between about 1 and about 5 weight percent, based upon the total weight of the reduced-fat flavored spread.

4. The composition in accordance with claim 1, wherein said aqueous flavored phase syrup component has a fruit flavor and includes natural fruit sources.

5. The composition in accordance with claim 1, further including up to about 10 weight percent of a sterol ester, based upon the total weight of the reduced-fat flavored spread.

6. The composition in accordance with claim 1, wherein said oil phase component is present at a level of up to about 45 weight percent, based upon the total weight of the reduced-fat flavored spread.

7. The composition in accordance with claim 1, wherein said flavored syrup composition includes up to about 60 weight percent water based upon the total weight of the reduced-fat flavored spread.

8. The composition in accordance with claim 1, wherein said emulsifier component is an emulsifier system comprising between 0 and about 80 weight percent of a monoglyceride component, between 0 and about 50 weight percent of a lecithin component, and between 0 and about 90 weight percent of a polyglycerol ester component, each being based upon the total weight of the reduced-fat flavored spread.

9. The composition in accordance with claim 8, including at least about 10 weight percent of the monoglyceride component and at least about 50 weight percent of the polyglycerol ester component, both based upon the total weight of the reduced-fat flavored spread.

10. The composition in accordance with claim 1, further including between 0 and about 5 weight percent of a whey protein concentrate, based upon the total weight of the reduced-fat flavored spread.

11. The composition in accordance with claim 1, further including up to about 100 micrograms of folic acid, based upon the total per gram weight of the reduced-fat spread composition.

12. The composition in accordance with claim 1, wherein said reduced-fat flavored spread is a roll-in margarine-type spread.

13. The composition in accordance with claim 1, wherein said reduced-fat flavored spread is a spread usable at ambient temperature for spreading onto ready-to-eat baked food products.

14. A reduced-fat flavored spread, which originated from a plurality of phases combined into a unitary spread, comprising:
up to about 65 weight percent of an oil phase composition, based upon the total weight of the flavored spread, said oil phase composition including at least about 80 weight percent of an hydrogenated vegetable oil component, based upon the weight of the oil phase composition;
a least about 35 weight percent of an aqueous flavored syrup phase composition, based upon the total weight of the reduced-fat flavored spread, said aqueous flavored syrup phase composition including at least about 30 weight percent of a flavor component, based upon the total weight of the reduced-fat flavored spread;
up to about 8 weight percent of an emulsifier component, based upon the total weight of the reduced-fat flavored spread, said emulsifier component being included in said oil phase composition;
up to about 8 weight percent, based on the total weight of the reduced-fat flavored spread, of a natural source water binding agent including oligofructose, said agent being included in said aqueous flavored syrup phase composition; and
said reduced-fat flavored spread is an oil-continuous edible product.

15. The composition in accordance with claim 14, wherein said emulsifier component is an emulsifier system comprising between 0 and about 80 weight percent of a monoglyceride component, between 0 and about 50 weight percent of a lecithin component, and between 0 and about 90 weight percent of a polyglycerol ester component, each being based upon the total weight of the reduced-fat flavored spread.

16. The composition in accordance with claim 14, further including up to about 10 weight percent of a sterol ester, based upon the total weight of the reduced-fat flavored spread.

17. The composition in accordance with claim 14, wherein said oil phase composition is present at a level of up to about 45 weight percent, based upon the total weight of the reduced-fat flavored spread, and said reduced-fat flavored spread is a spread usable at ambient temperature for spreading onto ready-to-eat baked food products.

18. The composition in accordance with claim 15, including at least about 10 weight percent of the monoglyceride component and at least about 50 weight percent of the polyglycerol ester component, based upon the total weight of the reduced-fat flavored spread.

19. The composition in accordance with claim 14, wherein said oil phase composition is present at a level of up to about 65 weight percent, and said reduced-fat flavored spread is a roll-in margarine-type spread.

20. A baked product having been made with a dough and a laminating edible oil spread, wherein said laminating edible oil spread is a reduced-fat flavored spread composition which is a combination of:
up to about 65 weight percent of an oil phase composition, based upon the total weight of the flavored spread, said oil composition including at least about 80 weight percent of an hydrogenated vegetable oil component, based on the weight of the oil composition;
a least about 35 weight percent of an aqueous flavored syrup composition, based upon the total weight of the reduced-fat flavored spread, said aqueous flavored syrup composition including at least about 30 weight percent of a flavor component, based upon the total weight of the reduced-fat flavored spread;
up to about 8 weight percent of an emulsifier component, based upon the total weight of the reduced-fat flavored spread; and
said reduced-fat flavored spread is an oil-continuous edible product; and
said baked product has at least about 20 percent less fat than an otherwise identical baked product made with a laminating ingredient which is a conventional margarine-type product having approximately 80 weight percent fat.

21. The baked product in accordance with claim 20, wherein said aqueous flavored syrup composition is fruit flavored and includes natural fruit sources.

22. The baked product in accordance with claim 20, wherein said emulsifier is an emulsifier system comprising between 0 and about 80 weight percent of a monoglyceride component, between 0 and about 50 weight percent of a lecithin component, and between 0 and about 90 weight percent of a polyglycerol ester component, each being based upon the total weight of the reduced-fat flavored spread.

23. The baked product in accordance with claim 22, including at least about 10 weight percent of the monoglyceride component and at least about 50 weight percent of the polyglycerol ester component, both based upon the total weight of the reduced-fat flavored spread.
